(19) United States
(12) Patent Application Publication
(10) Pub. No.: US 2024/0104513 A1
(43) Pub. Date: Mar. 28, 2024

(54) SCHEDULE SHARING METHOD, APPARATUS, AND DEVICE

(71) Applicant: Beijing Zitiao Network Technology Co., Ltd., Beijing (CN)

(72) Inventors: Zhaoyi LIU, Beijing (CN); Danyang ZHANG, Beijing (CN); Changyu GUO, Beijing (CN); Xingrun CHEN, Beijing (CN); Gang HU, Beijing (CN); Zhong Huang, Beijing (CN); Haohui QU, Beijing (CN); Xianjun LV, Beijing (CN)

(21) Appl. No.: 18/531,203

(22) Filed: Dec. 6, 2023

Related U.S. Application Data
(63) Continuation of application No. PCT/CN2022/098071, filed on Jun. 10, 2022.

(30) Foreign Application Priority Data
Jun. 21, 2021 (CN) 202110687687.0

(51) Int. Cl. G06Q 10/1093; H04L 9/40

(52) U.S. Cl. CPC G06Q 10/1093; H04L 63/10

(57) ABSTRACT

The embodiments of the present disclosure disclose a schedule sharing method, apparatus, and device, the schedule sharing method includes: determining a schedule to be shared after detecting a trigger operation of a first user; and sending the schedule to be shared to a target object based on a share operation triggered the first user. The target object is a page or webpage accessed by a user having an access authority. When a second user views the schedule information of the schedule to be shared through the target object, the authority information of the second user with respect to the schedule to be shared is obtained, so that an operation control matching authority information of the second user is displayed on the page corresponding to the schedule to be shared, thereby allowing the second user to interact with the schedule to be shared through the operation control.

### CROSS-REFERENCE TO RELATED PRESENT DISCLOSURE

The present application is a continuation of International Patent Application No. PCT/CN2022/098071, filed on Jun. 10, 2022, which claims priority of the Chinese Patent Application No. 202110687687.0, filed to on Jun. 21, 2021, and the entire content disclosed by the aforementioned patent applications is incorporated herein by reference as part of the present application.

### TECHNICAL FIELD

The present disclosure relates to computer processing technology, in particular to a schedule sharing method, apparatus, and device.

### BACKGROUND

With the continuous development of Internet technology, an increasing number of present disclosures have emerged that are easy to use to cater to people's needs. Among them, a schedule present disclosure has become crucial aids for people's work. By creating schedules, users can receive reminders for participating in or performing a certain task. Additionally, the schedule can also be shared with relevant parties to notify them to participate in scheduled activities or inform them of one's own itinerary. Nevertheless, the current approach of sharing a schedule on a page or webpage only allows for displaying the schedule information, while lacks interactive functionality on this basis, thereby affecting the user experience.

### SUMMARY

In view of this, the embodiments of the present disclosure provide a schedule sharing method, apparatus, and device, which not only can achieve the display of schedule information but also can support an operation by a user on a schedule, thus enhancing the user experience.

In order to achieve the above objectives, the technical solution provided by the embodiments of the present disclosure is as follows.

In a first aspect of the embodiments of the present disclosure, a schedule sharing method is provided, and the schedule sharing method comprises: in response to a trigger operation of a first user, determining a schedule to be shared; in response to a share operation of the first user, sharing the schedule to be shared to a target object, the target object being a page or webpage accessed by a user having an access authority; and in response to a second user accessing the target object, displaying an operation control matching authority information of the second user on a page corresponding to the schedule to be shared, allowing the second user to achieve to interact with the schedule to be shared through the operation control, the authority information of the second user being used to indicate whether the second user has an access authority to the schedule to be shared.

In a specific implementation, the in response to a second user accessing the target object, displaying an operation control matching authority information of the second user on a page corresponding to the schedule to be shared comprises: in response to the second user accessing the target object and the authority information of the second user indicating that the second user is not a participant of the schedule to be shared, displaying a first operation control on the page corresponding to the schedule to be shared, allowing the second user to apply to join the schedule to be shared by triggering the first operation control.

In a specific implementation, the in response to a second user accessing the target object, displaying an operation control matching authority information of the second user on a page corresponding to the schedule to be shared comprises: in response to the second user accessing the target object and the authority information of the second user indicating that the second user is a participant of the schedule to be shared, displaying a second operation control in the page corresponding to the schedule to be shared, allowing the second user to reply to the schedule to be shared through the second operation control.

In a specific implementation, the second operation control comprises at least one of following: a first control for accepting the schedule to be shared, a second control for rejecting the schedule to be shared, and a pending control.

In a specific implementation, the method further comprises: in response to a trigger operation of the second user on a target control, updating a content corresponding to the target control on the page corresponding to the schedule to be shared, where the target control is any one of second operation controls.

In a specific implementation, the method further comprises: in response to the second user accessing the target object, displaying schedule information matching the authority information in the page corresponding to the schedule to be shared according to the authority information of the second user.

In a specific implementation, the in response to the second user accessing the target object, displaying schedule information matching the authority information in the page corresponding to the schedule to be shared according to the authority information of the second user comprises: in response to the second user accessing the target object and the second user having the access authority to the schedule to be shared, displaying first schedule information in the page corresponding to the schedule to be shared, the first schedule information comprising detailed information related to the schedule to be shared.

In a specific implementation, the in response to the second user accessing the target object, displaying schedule information matching the authority information in the page corresponding to the schedule to be shared according to the authority information of the second user comprises: in response to the second user accessing the target object and the second user not having the access authority to the schedule to be shared, displaying second schedule information in the page corresponding to the schedule to be shared, the second schedule information comprising summary information related to the schedule to be shared.

In a specific implementation, the in response to a trigger operation of a first user, determining a schedule to be shared, comprises: in response to an insert operation triggered by the first user in the target object, receiving a schedule identifier input by the first user, and displaying one or more schedules comprising the schedule identifier; and in response to a selection operation by the first user on the one or more schedules, determining a selected schedule as the schedule to be shared.

In a specific implementation, the in response to a share operation of the first user, sharing the schedule to be shared to a target object comprises: in response to a confirmation operation by the first user on the schedule to be shared, inserting the schedule to be shared into the target object in a form of a schedule card.

In a specific implementation, the method further comprises: in response to a trigger operation by the second user on the schedule to be shared, switching a display mode of the schedule to be shared, where the display mode comprises a schedule card or path information, and the path information indicates a path to obtain the schedule to be shared.

In a specific implementation, the in response to a trigger operation of a first user, determining a schedule to be shared comprises: in response to a selection operation by the first user on a schedule page, determining the schedule to be shared, the schedule page comprising the schedule to be shared; and the in response to a share operation of the first user, sharing the schedule to be shared to a target object comprises: in response to a share operation by the first user on the schedule to be shared, adding path information corresponding to the schedule to be shared to the target object.

In a specific implementation, the in response to a share operation by the first user on the schedule to be shared, adding path information corresponding to the schedule to be shared to the target object comprises: in response to a trigger operation by the first user on a sharing component in the schedule page, displaying a page comprising the target object; and in response to a selected operation by the first user on the page with respect to the target object, adding the path information corresponding to the schedule to be shared to the target object.

In a specific implementation, the in response to a share operation by the first user on the schedule to be shared, adding path information corresponding to the schedule to be shared to the target object comprises: in response to a trigger operation by the first user on a path information copy component in the schedule page, obtaining the path information corresponding to the schedule to be shared; and in response to a selected operation by the first user on the target object, adding the path information corresponding to the schedule to be shared to the target object.

In a specific implementation, the path information comprises a link corresponding to the schedule to be shared.

In a specific implementation, the method further comprises: in response to a trigger operation by the second user on the path information corresponding to the schedule to be shared, acquiring an identifier corresponding to the schedule to be shared and authority information of the second user for the schedule to be shared from the path information corresponding to the schedule to be shared; acquiring schedule information and interactive information corresponding to the schedule to be shared from a calendar server according to the identifier and the authority information of the second user for the schedule to be shared, where the calendar server stores the schedule information corresponding to the schedule to be shared, and the interactive information indicates a content that the second user can interact with the schedule to be shared; and by means of the schedule information and the interactive information, rendering the path information corresponding to the schedule to be shared into a schedule card, and displaying the schedule information and the interactive information in the schedule card.

In a specific implementation, the target object comprises a shared document.

In a specific implementation, the schedule to be shared presented in the target object is generated by: in response to the trigger operation of the first user, acquiring a schedule block of the schedule to be shared through a sharing platform, where the schedule block is generated by a schedule server based on a data standard of the sharing platform, and the data standard is used to indicate a field that needs to be displayed in the schedule block; and displaying the schedule block of the schedule to be shared.

In a specific implementation, the acquiring a schedule block of the schedule to be shared through a sharing platform comprises: sending a schedule insertion request to the sharing platform, where the schedule insertion request comprises an identifier of the schedule to be shared, to enable the sharing platform to search for the schedule block locally according to the identifier of the schedule to be shared, or request the schedule block from the schedule server; and receiving the schedule block sent by the sharing platform.

In a specific implementation, the method further comprises: receiving an update message sent by the sharing platform, where the update message comprises an identifier of the schedule block and the update message is sent by the schedule server to the sharing platform; determining authority information of the second user for the schedule block according to the identifier of the schedule block; sending an update request to the sharing platform according to the authority information of the second user for the schedule block, where the update request is used for requesting updated schedule information conforming to the authority information of the second user for the schedule block; and receiving the updated schedule information conforming to the authority information of the second user for the schedule block sent by the sharing platform and displaying the updated schedule information.

In a second aspect of the embodiments of the present disclosure, a schedule sharing apparatus is provided, and the apparatus comprises: a determining unit, configured to determine a schedule to be shared in response to a trigger operation of a first user; a sharing unit, configured to share the schedule to be shared to a target object in response to a share operation of the first user, the target object being a page or webpage accessed by a user having an access authority; and a display unit, configured to, in response to a second user accessing the target object, display an operation control matching authority information of the second user in a page corresponding to the schedule to be shared, allowing the second user to achieve to interact with the schedule to be shared through the operation control, the authority information of the second user being used to indicate whether the second user has an access authority to the schedule to be shared.

In a third aspect of the embodiments of the present disclosure, an electronic device is provided, and the device comprises a processor and a memory, the memory is configured to store instructions or computer programs; and the processor is configured to execute the instructions or the computer programs in the memory to enable the electronic device to perform the method according to the first aspect.

In a fourth aspect of the embodiments of the present disclosure, a non-transitory computer-readable storage medium is provided, and the non-transitory computer-readable storage medium comprises instructions which, when run on a computer, cause the computer to perform the method according to the first aspect.

In a fifth aspect of the embodiments of the present disclosure, a computer program product is provided, the computer program product comprises computer programs/instructions, when the programs/instructions are executed by a processor, the method according to the first aspect is implemented.

It can be seen that the embodiments of the present disclosure have the following beneficial effects.

According to the technical solutions provided by the embodiments of the present disclosure, a schedule to be shared is determined after a trigger operation of a first user is detected, and the schedule to be shared is sent to a target object based on a share operation triggered by the first user. Here, the target object is a page or webpage accessed by a user having an access authority. When there is a second user viewing the schedule information of the schedule to be shared through the target object, the authority information of the second user with respect to the schedule to be shared is obtained, so that based on the authority information, an operation control matching the authority information of the second user is displayed on the page corresponding to the schedule to be shared, thereby allowing the second user to interact with the schedule to be shared through the operation control. That is, through the scheme provided by the embodiments of the present disclosure, the second user can not only view the schedule information of the schedule to be shared, but also achieve the interaction, thus improving the user experience.

### BRIEF DESCRIPTION OF THE DRAWINGS

FIG. 1 is a flowchart of a schedule sharing method provided by an embodiment of the present disclosure;

FIG. 2a is a schematic diagram of determining a schedule to be shared according to an embodiment of the present disclosure;

FIG. 2b is another schematic diagram of determining a schedule to be shared according to an embodiment of the present disclosure;

FIG. 2c is a schematic diagram of displaying a card for a schedule to be shared according to an embodiment of the present disclosure;

FIG. 2d is another schematic diagram of displaying a card for a schedule to be shared according to an embodiment of the present disclosure;

FIG. 2e is still another schematic diagram of displaying a card for a schedule to be shared according to an embodiment of the present disclosure;

FIG. 3a is a schematic diagram of displaying a link for a schedule to be shared according to an embodiment of the present disclosure;

FIG. 3b is a schematic diagram of displaying an operation control for a schedule to be shared according to an embodiment of the present disclosure;

FIG. 3c is another schematic diagram of displaying an operation control for a schedule to be shared according to an embodiment of the present disclosure;

FIG. 3d is still another schematic diagram of displaying an operation control for a schedule to be shared according to an embodiment of the present disclosure;

FIG. 3e is a schematic diagram of an interactive effect according to an embodiment of the present disclosure;

FIG. 4a is a schematic diagram of adjusting a display mode according to an embodiment of the present disclosure;

FIG. 4b is another schematic diagram of adjusting a display mode according to an embodiment of the present disclosure;

FIG. 5 is an interaction diagram of schedule block transfer according to an embodiment of the present disclosure;

FIG. 6 is a structural diagram of a schedule sharing apparatus provided by an embodiment of the present disclosure; and

FIG. 7 is a structural diagram of an electronic device provided by an embodiment of the present disclosure.

### DETAILED DESCRIPTION

In order to make the above objects, features, and advantages of the present disclosure more obvious and understandable, the embodiments of the present disclosure will be further described in detail with the accompanying drawings and specific implementations. It can be understood that the specific embodiments described here are only used to explain the present disclosure, and do not intend to limit the present disclosure. In addition, it should be noted that, for the convenience of description, the accompanying drawings only show the parts relevant to the present disclosure, and not the entire structure.

Currently, when inserting a schedule into a page or webpage such as a shared document, only partial information of the schedule is displayed in the shared document, so that the user cannot view detailed information of the schedule and also cannot interact on the basis of a schedule block. Furthermore, traditional schedule insertion only allows static display of partial information of the schedule, and when the information of the schedule is updated, the changes in the information of the schedule cannot be detected, thus affecting the user experience.

Based on this, an embodiment of the present disclosure provides a schedule sharing method. After a first user selects a schedule to be shared which is to be inserted, the schedule to be shared is shared with a target object in response to a share operation of the first user. When a second user accesses the target object, an operation control matching the authority information of the second user is determined according to the authority information of the second user, the operation control is displayed in the page corresponding to the schedule to be shared, so that the second user can interact with the schedule to be shared through the operation control. Here, the authority information of the second user is used to indicate whether the second user has an access authority to the schedule to be shared.

In addition, when the schedule information of the schedule to be shared is updated, the schedule information corresponding to the schedule to be shared in the target object will be updated in real time, so that the user can view the real-time schedule information.

In order to facilitate understanding, the technical solutions provided by the embodiments of the present disclosure will be described below with reference to the drawings.

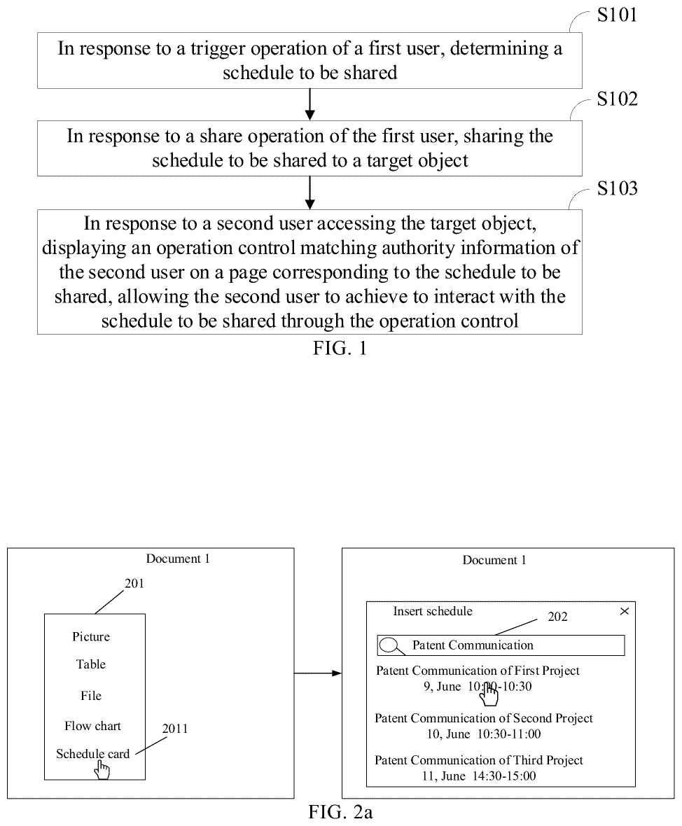

Referring to FIG. 1, which is a flowchart of a schedule sharing method provided by an embodiment of the present disclosure, as shown in FIG. 1, the method may comprise the following steps.

S101, in response to a trigger operation of a first user, determining a schedule to be shared.

In the embodiment, when the first user wants to insert the schedule to be shared into a target object, firstly, the schedule to be shared is determined in response to the trigger operation of the first user. Here, the target object is a page or webpage accessed by a user having an access authority. For example, the target object is a shared document. Here, the shared document may refer to, for example, an online document that allows the user to access and operate with assigned user authority. For example, the user may have the authority to browse the shared document and/or edit the shared document in real time. Schematically, if the user has the authority to edit the shared document in real time, the editing effect of the shared document will be synchronized to the pages of other users who are accessing the shared document and have the access authority to the shared document in real time.

The first user can determine the schedule to be shared through the following methods.

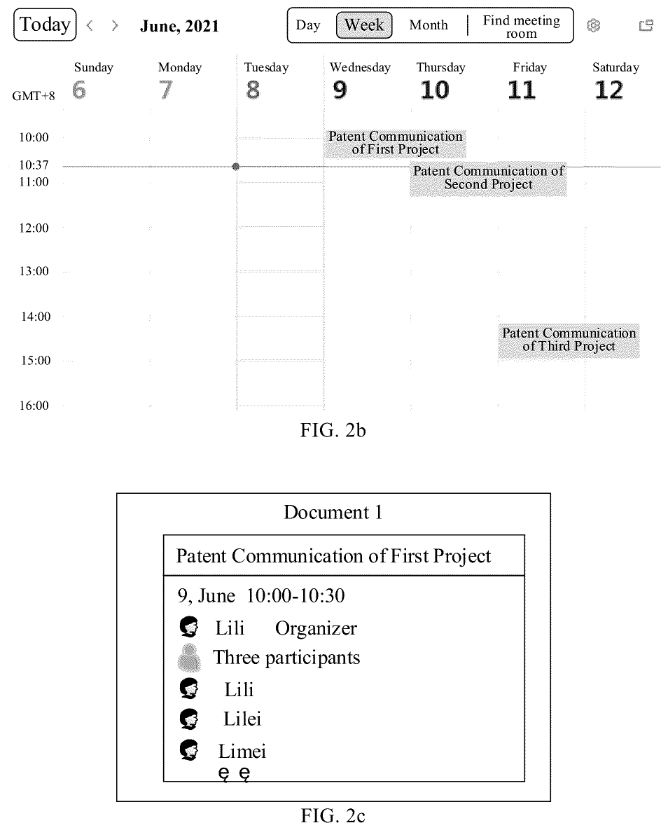

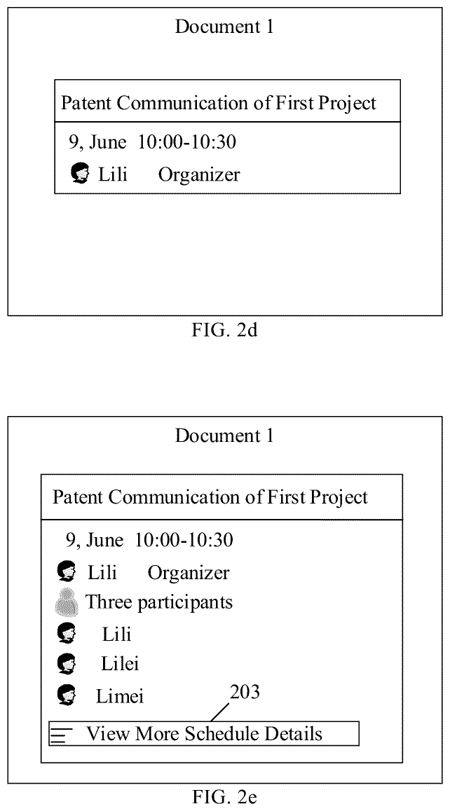

One method is to determine the schedule to be shared on a target object side. Specifically, in response to an insert operation triggered by the first user in the target object, a schedule identifier input by the first user is received, and one or more schedules comprising the schedule identifier is displayed; and in response to a selection operation by the first user on the one or more schedules, a selected schedule is determined as the schedule to be shared. For example, the first user clicks on an insertion control in the target object to display a menu comprising a schedule card option. The first user triggers the schedule card option to enable a search input box to pop up. The first user can input the search keyword (for example, one or more selected from a group comprising a theme of the schedule, names of participants, the start time of the schedule, and the end time of the schedule) of the schedule that the first user wants to insert in the search input box, a server corresponding to the target object can request one or more schedules comprising the search keyword from a server corresponding to a schedule application according to the search keyword input by the first user, and then the one or more schedules comprising the search keyword is displayed below the search input box. The first user can select the schedule to be inserted from the one or more schedules that is displayed. For example, as shown in FIG. 2a, the first user can invoke a menu 201 comprising a schedule card option through a corresponding trigger operation in a shared document. In response to a trigger operation by the first user on a schedule card 2011 in the menu 201, a schedule search input box 202 is displayed. The first user can input the search keyword of the schedule as “Patent Communication” in the search input box corresponding to the schedule card, and then a plurality of schedules, themes of which comprise “Patent Communication”, are displayed below the search input box, such as “Patent Communication of First Project”, “Patent Communication of Second Project”, and “Patent Communication of Third Project”. If the first user selects “Patent Communication of First Project”, then the schedule “Patent Communication of First Project” is the schedule to be shared.

The other method is to determine the schedule to be shared on a schedule side by the first user. Specifically, the schedule to be shared is determined in response to a selection operation of the first user on a schedule page, the schedule page comprises the schedule to be shared. For example, a first user can enter a calendar application, one or more established schedules can be presented in the calendar application, and the first user can select a schedule that is to be shared in the calendar application, and take the selected schedule as the schedule to be shared. As shown in FIG. 2b, three established schedules “Patent Communication of First Project”, “Patent Communication of Second Project”, and “Patent Communication of Third Project” are displayed in the calendar application, and the first user can select a schedule that is to be shared.

S102, in response to a share operation of the first user, sharing the schedule to be shared to a target object.

In the embodiment, after the first user determines the schedule to be shared, the schedule to be shared is shared to the target object in response to the share operation of the first user. Here, the target object is a page or webpage accessed by a user having an access authority.

Specifically, when the schedule to be shared is determined by the first user on the target object side, the schedule to be shared is inserted into the target object in the form of a schedule card in response to a confirmation operation by the first user on the schedule to be shared. For example, as shown in FIG. 2c, after the first user selects the schedule “Patent Communication of First Project”, the schedule information of “Patent Communication of First Project” will be displayed in a shared document 1 in the form of a schedule card.

When the schedule information corresponding to the schedule to be shared is displayed in the target object in the form of a schedule card, the schedule information is displayed according to the authority information of the first user. When the first user has the authority to view the schedule to be shared, first schedule information of the schedule to be shared is displayed in the target object, and the first schedule information comprises detailed information of the schedule to be shared, the detailed information comprises, for example, the theme of the schedule, the time of the schedule, the organizer of the schedule, the participant of the schedule, and the reply content of each participant to the schedule, as shown in FIG. 2c. When the first user does not have the authority to view the schedule to be shared, second schedule information of the schedule to be shared is displayed in the target object, and the second schedule information comprises summary information of the schedule to be shared, for example, the summary information comprises only the theme of the schedule, the time of the schedule, and the organizer of the schedule. For example, as shown in FIG. 2d, when the first user does not have the authority to view “Patent Communication of First Project”, only the theme of the schedule, the time of the schedule, and the organizer of the schedule are displayed.

It should be noted that in practical application, when the schedule information of the schedule to be shared is displayed in the form of a schedule card in the target object, because the user having the access authority can view all the information of the schedule, in order to facilitate the display in the target object and viewing by the user, only part information of the schedule and a control of “View More Schedule Details” can be displayed in the schedule card, and in response to a trigger operation of the user on the control, a detail page is displayed, more information related to the schedule can be viewed in the detail page. For example, as shown in FIG. 2e, the first user has the authority to view “Patent Communication of First Project”, and when the card of the schedule is displayed in the shared document 1, the theme of the schedule, the time of the schedule, the organizer of the schedule, and a control 203 of “View More Schedule Details” can be displayed. The first user can view the schedule information related to the schedule to be shared by clicking the control 203 of “View More Schedule Details”.

In some application scenarios, when the first user inserts a schedule into a target object on a PC side, in response to the trigger operation of the user on the control of “View More Schedule Details”, the detail page can be directly displayed to show the detailed information of the schedule. In other application scenarios, when the first user inserts a schedule into a target object on a mobile side, in response to the trigger operation of the user on the control “View More Schedule Details”, jumping to a calendar page and displaying the detailed information of the schedule on the calendar page.

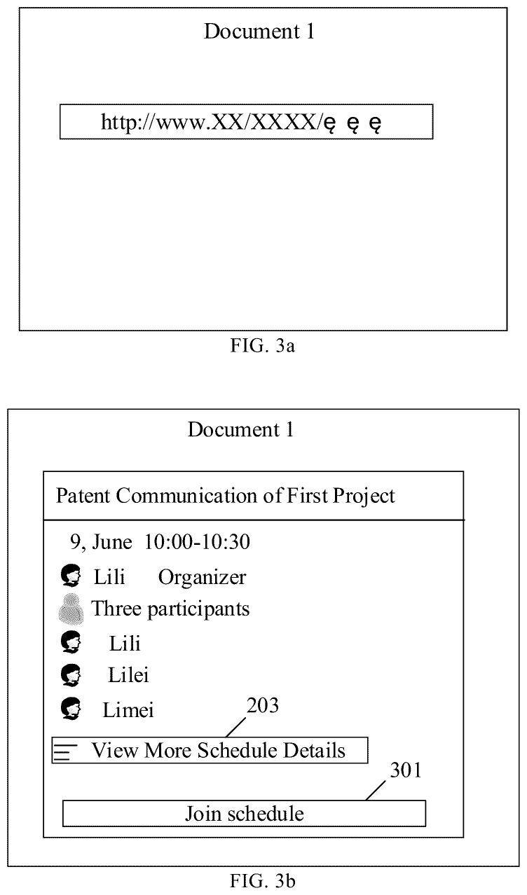

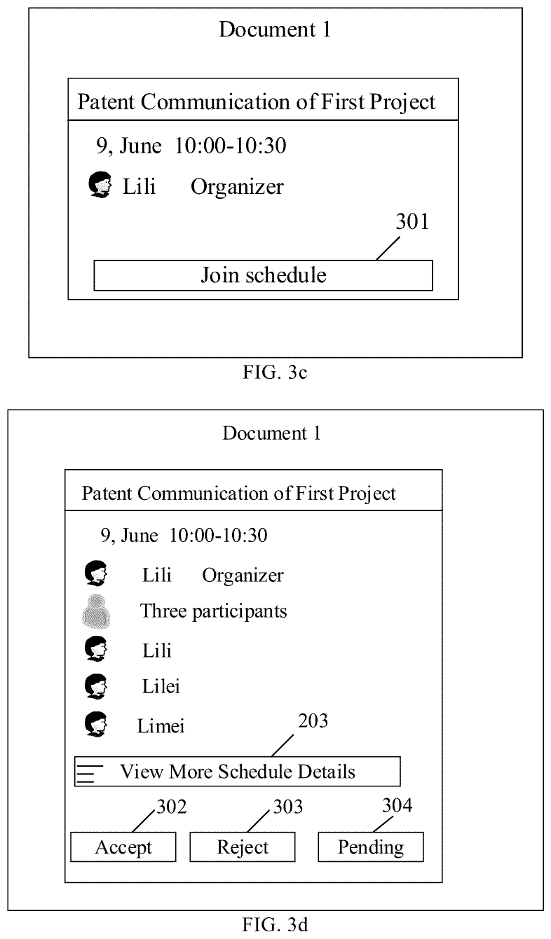

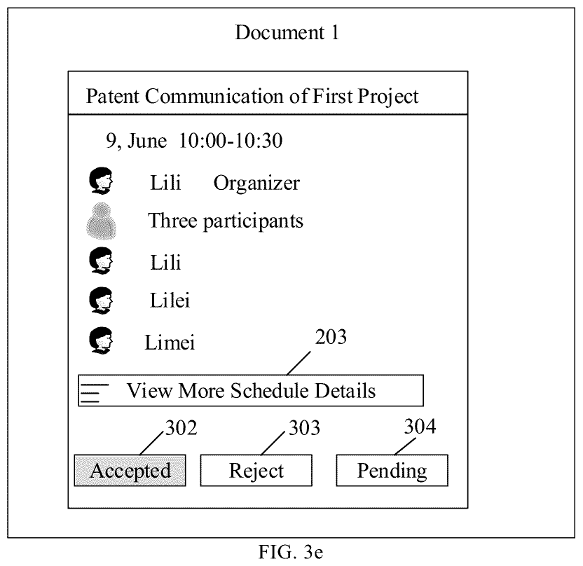

Specifically, when the schedule to be shared is determined by the first user on the schedule page, path information corresponding to the schedule to be shared is added to the target object in response to the share operation by the first user on the schedule to be shared. The path information is used to indicate a path to obtain the schedule to be shared, and may be a link or a QR code of the schedule to be shared. In one example, a page comprising the target object is displayed in response to a trigger operation by the first user on a sharing component in the schedule page corresponding to the schedule to be shared; and the path information corresponding to the schedule to be shared is added to the target object in response to a selected operation by the first user on the above page with respect to the target object. In another example, the path information corresponding to the schedule to be shared is obtained in response to a trigger operation by the first user on a path information copy component in the schedule page; and the path information corresponding to the schedule to be shared is added to the target object in response to the selected operation by the first user on the target object. As shown in FIG. 3a, the path information corresponding to the schedule to be shared is the link of the schedule to be shared, and the user inserts the link of the schedule to be shared in the shared document 1. The selected operation on the target object indicates that the target object has been selected by the user.

S103, in response to a second user accessing the target object, displaying an operation control matching authority information of the second user on a page corresponding to the schedule to be shared, allowing the second user to achieve to interact with the schedule to be shared through the operation control.

In this embodiment, after the first user inserts the schedule to be shared into the target object, any other user (second user) can browse the inserted schedule to be shared through the target object when accessing the target object. At the same time, the operation control matching the authority information of the second user will be displayed on the page corresponding to the schedule to be shared according to the authority information of the second user, thus allowing the second user to achieve to interact with the schedule to be shared through the operation control. Here, the authority information of the second user is used to indicate whether the second user has an access authority to the schedule to be shared. When the second user has the access authority to the schedule to be shared, the second user may be a participant of the schedule to be shared or a collaborator of a calendar to which the schedule to be shared belongs. When the second user does not have the access authority to the schedule to be shared, it means that the second user is neither a participant of the schedule to be shared nor a collaborator of the calendar to which the schedule to be shared belongs. Here, the participant of the schedule to be shared refers to a participant added by a creator of the schedule to be shared when creating the schedule.

In one example, in response to the second user accessing the target object and the authority information of the second user indicating that the second user is not a participant of the schedule to be shared, a first operation control is displayed in the page corresponding to the schedule to be shared which is displayed to the second user, so that the second user can apply to join the schedule to be shared through the first operation control. Specifically, when the second user is not a participant of the schedule to be shared, but is a collaborator of the calendar to which the schedule to be shared belongs, the theme of the schedule, the time of the schedule, the organizer of the schedule, the participant of the schedule, and the first operation control can be displayed in the page corresponding to the schedule to be shared. As shown in FIG. 3b, the page corresponding to the schedule to be shared comprises a joining schedule control 301 (first operation control). When the second user is neither a participant of the schedule to be shared nor a collaborator of the calendar to which the schedule to be shared belongs, the page corresponding to the schedule to be shared can only display the theme of the schedule, the time of the schedule, the organizer of the schedule, and the first operation control. As shown in FIG. 3c, the page corresponding to the schedule to be shared comprises a joining schedule control 301 (first operation control). The second user applies to join the schedule by triggering the joining schedule control. Whether the second user can successfully join the schedule to be shared inserted in the target object will be determined according to the permissions set by the organizer of the schedule.

In another example, in response to the second user accessing the target object and the second user being a participant of the schedule to be shared, a second operation control is displayed in the page corresponding to the schedule to be shared, thus allowing the second user to reply to the schedule to be shared through the second operation control. The second operation control include at least one of the following: a control for accepting the schedule to be shared, a control for rejecting the schedule to be shared, and a pending control. For example, as shown in FIG. 3d, an accepting control 302, a rejecting control 303, and a pending control 304 are displayed on the page corresponding to the schedule to be shared, and the second user can trigger any of the above controls.

In specific implementation, in response to a trigger operation of the second user on a target control, the content corresponding to the target control is updated on the page corresponding to the schedule to be shared. Here, the target control is any one of the second operation controls. For example, when the second user triggers the control 302, the control 302 will be displayed as accepted, as shown in FIG. 3e; when the second user triggers the control 303, the control 303 will be displayed as rejected; and when the second user triggers the control 304, the control 304 will be displayed as pending.

In practical application, when the second user browses the schedule to be shared by accessing the target object, not only the interactive control but also the schedule information can be displayed. Specifically, according to the authority information of the second user, the schedule information matched with the authority information is displayed in the page corresponding to the schedule to be shared. In one case, in response to the second user accessing the target object and the second user having the access authority to the schedule to be shared, the first schedule information is displayed in the page corresponding to the schedule to be shared, and the first schedule information comprises detailed information related to the schedule to be shared. Here, the display mode of the schedule information of the schedule to be shared is shown in FIGS. 2c and 2e. In another case, when the second user does not have the access authority to the schedule to be shared inserted in the target object and the second user accesses the target object, the second schedule information is displayed in the page corresponding to the schedule to be shared. The second schedule information comprises summary information related to the schedule to be shared. For example, the summary information may comprise the theme of the schedule, the time of the schedule, and the organizer of the schedule, as shown in FIG. 2d.

It can be seen from the above description that the schedule to be shared is determined after the trigger operation of the first user is detected, and the schedule to be shared is sent to the target object based on the share operation triggered by the first user. Here, the target object is a page or webpage accessed by a user having an access authority. When there exists a second user who views the schedule information of the schedule to be shared through the target object, the authority information of the second user for the schedule to be shared is obtained, and based on the authority information, an operation control matching the authority information of the second user is displayed on the page corresponding to the schedule to be shared, thus allowing the second user to interact with the schedule to be shared through the operation control. That is, through the solution provided by the embodiments of the present disclosure, the second user can not only view the schedule information of the schedule to be shared but also achieve to interact with the schedule to be shared, thus enhancing the user experience.

Based on the above description, it can be understood that the schedule to be shared may be displayed in the target object in the form of a schedule card or path information, and to facilitate usage by the user, it is also possible to switch between the above different display modes according to the trigger operation of the user.

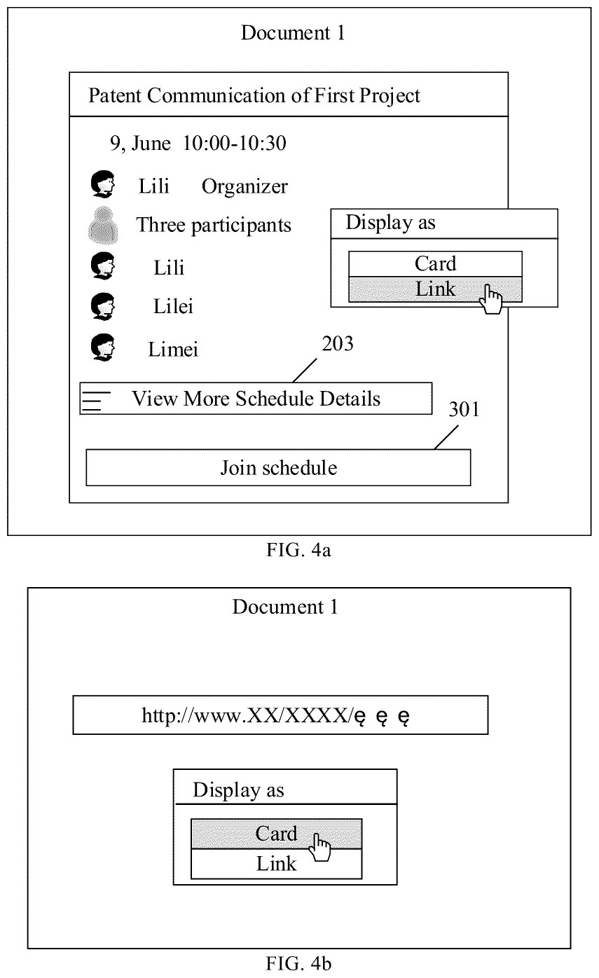

Specifically, in a specific implementation, when the schedule to be shared is inserted into the target object in the form of a schedule card, the display mode of the schedule to be shared is adjusted from the schedule card to the path information in response to a trigger operation of the second user on the schedule to be shared. For example, as shown in FIG. 4a, a schedule card is inserted into the target object, and through a trigger operation, the second user can invoke an adjustment page, and the second user can select the display mode of the schedule to be shared to be a link, that is, the second user can choose to display the schedule to be shared in the form of a link.

In a specific implementation, when the schedule to be shared is inserted into the target object in the form of path information, the display mode of the schedule to be shared is adjusted from the path information to the schedule card in response to a trigger operation of the second user on the schedule to be shared, and the schedule to be shared is displayed in the target object in the form of a schedule card. As shown in FIG. 4b, a link of the schedule to be shared is inserted into the target object, and through a trigger operation, the second user can invoke an adjustment page, and the second user can select the display mode of the schedule to be shared to be a card, that is, the second user can choose to display the schedule to be shared in the form of a card.

Specifically, the link of the schedule to be shared in the target object can be rendered into a schedule card in the following ways. In response to a trigger operation by the second user on the path information corresponding to the schedule to be shared, an identifier corresponding to the schedule to be shared and the authority information of the second user for the schedule to be shared are obtained from the path information corresponding to the schedule to be shared; the schedule information and the interactive information corresponding to the schedule to be shared are acquired from a calendar server according to the identifier of the schedule to be shared and the authority information of the second user for the schedule to be shared; and by means of the schedule information and the interactive information, the path information corresponding to the schedule to be shared is rendered into a schedule card, and the schedule information and the interactive information are displayed in the schedule card. That is, when a server of the target object detects that the second user has adjusted the display mode of the schedule to be shared from the link to the schedule card, the server obtains the identifier of the schedule to be shared from the link, and also obtains the access authority of the second user to the schedule to be shared. The server of the target object sends the identifier of the schedule to be shared and the authority information of the second user to the calendar server, thus allowing the calendar server to obtain the schedule information and the interactive information related to the schedule to be shared according to the identifier of the schedule to be shared and the authority information of the second user. The calendar server stores all schedule information and interactive information corresponding to the schedule to be shared. When the second user has the access authority to the schedule to be shared, the obtained schedule information comprises detailed information of the schedule. When the second user does not have the access authority to the schedule to be shared, the obtained schedule information comprises summary information. The calendar server sends the acquired schedule information and interactive information to the server of the target object, and then the server of the target object returns the schedule information and interactive information to a front end of the target object, so as to render the schedule link of the schedule to be shared into a schedule card, thereby displaying the schedule to be shared in the target object in the form of a schedule card. Here, the interactive information is the content that the second user can interact with the schedule to be shared, including, for example, a joining schedule control, an accepting control, a rejecting control, a pending control, etc.

In a specific implementation, when the schedule to be shared is displayed in the target object, the schedule information of the schedule to be shared can also be updated, so that the user can browse the updated schedule information. Specifically, when the calendar server detects that the schedule information of a certain schedule is updated, the calendar server determines whether the schedule is shared. If it is determined that the schedule has been shared, an update message is sent to the server of the target object, and the update message comprises the identifier of the schedule to be shared. After receiving the update message, the server of the target object determines the authority information of the second user to the schedule to be shared according to the identifier of the schedule to be shared, and after determining the authority information of the second user to the schedule to be shared, the updated schedule information is requested from the calendar server according to the authority information of the second user to the schedule to be shared. Here, the updated schedule information is schedule information that the second user has the authority to view. After the updated schedule information is obtained, the updated schedule information is displayed on the page corresponding to the schedule to be shared in response to the second user viewing the schedule to be shared through the target object.

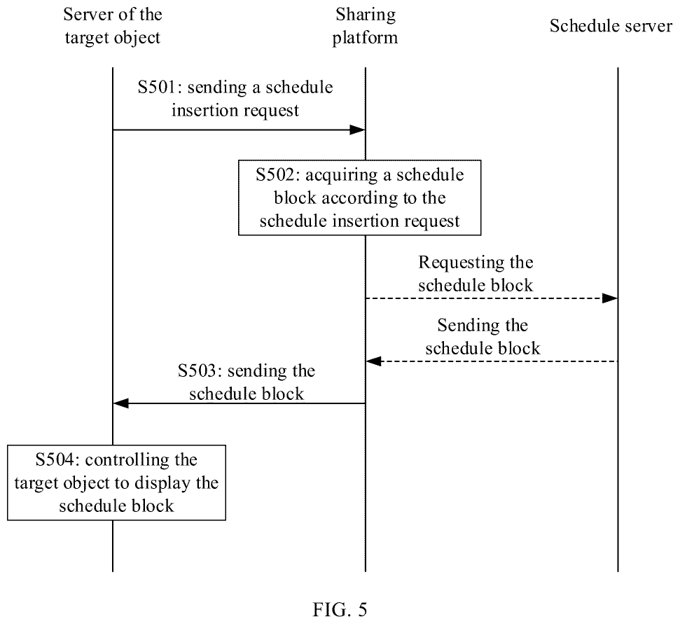

Here, the schedule to be shared presented in the target object can be obtained in the following ways. For ease of understanding, referring to the information interaction diagram shown in FIG. 5. As shown in FIG. 5, the interaction process comprises the following steps.

S501, in response to a trigger operation by the first user, the server of the target object sends a schedule insertion request to a sharing platform.

In this embodiment, when the first user inserts the schedule into the target object, the server of the target object sends the schedule insertion request to the sharing platform after detecting the trigger operation by the first user, so as to obtain an information block of the schedule to be shared through the schedule insertion request. Here, the insertion request comprises the identifier of the schedule to be shared.

S502, the sharing platform acquires a schedule block according to the schedule insertion request.

After receiving the schedule insertion request sent by the server of the target object, the sharing platform acquires the schedule block according to the schedule insertion request, the schedule block is generated by the schedule application based on the data standard of the sharing platform, and the data standard is used to indicate a field that needs to be displayed in the schedule block.

Specifically, the sharing platform looks for the schedule block locally according to the identifier of the schedule to be shared in the schedule insertion request, or requests the schedule block from a schedule server. After generating the schedule block of the schedule to be shared according to the data standard provided by the sharing platform, the schedule server can send the generated schedule block to the sharing platform for storage.

S503, the sharing platform sends the schedule block to the server of the target object.

S504, the server of the target object controls the target object to display the schedule block.

After obtaining the schedule block, the sharing platform sends the schedule block to the server of the target object, and the server of the target object controls the target object to display the schedule block.

That is, the embodiment of the present disclosure provides a sharing platform, and the schedule server creates a transferable schedule block based on the data standard provided by the sharing platform and provides the schedule block to the sharing platform. When the target object intends to display the schedule block, the server corresponding to the target object sends a request to the sharing platform. After receiving the schedule insertion request, the sharing platform obtains the schedule block according to the identifier in the request and sends the schedule block to the server of the target object, thereby allowing the server of the target object to control the target object to display the schedule block.

Further, in this embodiment, as a transfer platform for the data, the sharing platform provides data specifications and unified encapsulation. As long as a data provider and a data displayer have access to the sharing platform, data provided by any data provider can be inserted into the data displayer for display. Moreover, in a case where the data provided by the data provider is updated, when the data is displayed by the data displayer, the sharing platform can also provide the updated data to the data displayer in time, so that the data displayer can display the updated data when displaying the data. For example, a schedule block is inserted into a shared document, and when the schedule information corresponding to the schedule block is updated, the sharing platform can obtain the updated schedule information from the schedule server and send the updated schedule information to a server of the shared document, so that the server of the shared document can control the shared document to display the latest schedule information.

In addition, compared with a traditional method of inserting a schedule in instant messaging (IM) conversations, because the webpages or pages have a high degree of freedom and flexibility of spreading, by inserting a schedule to be shared into the webpage or page, the efficiency and scope of spreading the schedule to be shared can be increased, and it is no longer limited that only the users within the IM conversation can view the schedule to be shared. Specifically, when a plurality of users communicate through a shared document, the plurality of users can simultaneously learn about the relevant information of the schedule in the shared document, thus improving the efficiency of spreading and communication.

In some application scenarios, the schedule information of the schedule block inserted in the target object may be updated. In this case, the schedule server can send an update message to the sharing platform, and then the sharing platform can send the update message to the server of the target object. Here, the update message comprises an identifier of the schedule block. After receiving the update message, the server of the target object determines the authority information of the second user to the schedule block according to the identifier in the update message, and sends an update request to the sharing platform according to the authority information of the second user to the schedule block, the update request is used for requesting the updated schedule information conforming to the authority information of the second user to the schedule block. After receiving the update request, the sharing platform can request the updated schedule information from the schedule server according to the update request and send the updated schedule information to the server of the target object, so as to control the target object to display the updated schedule information. That is, the embodiment can implement information updating of the schedule to be shared which is inserted in the target object, so that the user can browse the latest schedule information.

Based on the above method embodiment, an embodiment of the present disclosure also provides a schedule sharing apparatus, which will be described with the accompanying drawings.

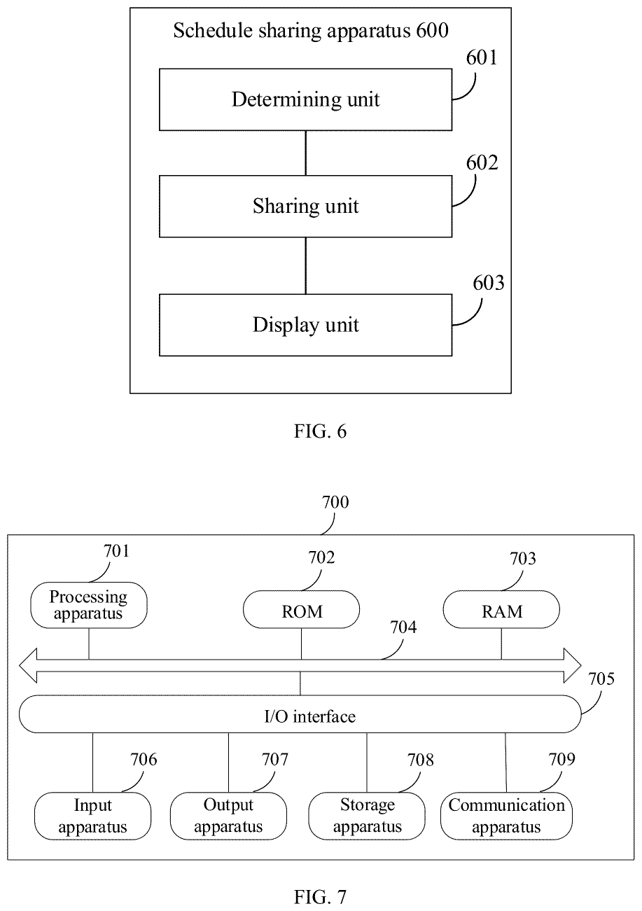

Referring to FIG. 6 which is a structural diagram of a schedule sharing apparatus 600 provided by an embodiment of the present disclosure, as shown in FIG. 6, the apparatus may comprise:
a determining unit 601, configured to determine a schedule to be shared in response to a trigger operation of a first user;
a sharing unit 602, configured to share the schedule to be shared to a target object in response to a share operation of the first user, the target object being a page or webpage accessed by a user having an access authority; and
a display unit 603, configured to, in response to a second user accessing the target object, display an operation control matching authority information of the second user in a page corresponding to the schedule to be shared, allowing the second user to achieve to interact with the schedule to be shared through the operation control, the authority information of the second user being used to indicate whether the second user has an access authority to the schedule to be shared.

In a specific implementation, the display unit 603 is specifically configured to display a first operation control on the page corresponding to the schedule to be shared in response to the second user accessing the target object and the authority information of the second user indicating that the second user is not a participant of the schedule to be shared, thus allowing the second user to apply to join the schedule to be shared by triggering the first operation control.

In a specific implementation, the display unit 603 is specifically configured to display a second operation control in the page corresponding to the schedule to be shared in response to the second user accessing the target object and the authority information of the second user indicating that the second user is a participant of the schedule to be shared, thus allowing the second user to reply to the schedule to be shared through the second operation control.

In a specific implementation, the second operation control comprises at least one of following: a first control for accepting the schedule to be shared, a second control for rejecting the schedule to be shared, and a pending control.

In a specific implementation, the apparatus further comprises an updating unit.

The updating unit is configured to, in response to a trigger operation of the second user on a target control, update a content corresponding to the target control on the page corresponding to the schedule to be shared, the target control is any one of second operation controls.

In a specific implementation, the display unit 603 is further configured to, in response to the second user accessing the target object, display schedule information matching the authority information of the second user in the page corresponding to the schedule to be shared according to the authority information of the second user.

In a specific implementation, the display unit 603 is specifically configured to display first schedule information in the page corresponding to the schedule to be shared in response to the second user accessing the target object and the second user having the access authority to the schedule to be shared. Here, the first schedule information comprises detailed information related to the schedule to be shared.

In a specific implementation, the display unit 603 is specifically configured to display second schedule information in the page corresponding to the schedule to be shared in response to the second user accessing the target object and the second user not having the access authority to the schedule to be shared. Here, the second schedule information comprises summary information related to the schedule to be shared.

In a specific implementation, the determining unit 601 is specifically configured to, in response to an insert operation triggered by the first user in the target object, receive a schedule identifier input by the first user, and display one or more schedules comprising the schedule identifier; and in response to a selection operation by the first user on the one or more schedules, determine a selected schedule as the schedule to be shared.

In a specific implementation, the sharing unit 602 is specifically configured to, in response to a confirmation operation by the first user on the schedule to be shared, insert the schedule to be shared into the target object in a form of a schedule card.

In a specific implementation, the apparatus further comprises a switching unit.

The switching unit is configured to switch a display mode of the schedule to be shared in response to a trigger operation by the second user on the schedule to be shared. Here, the display mode comprises a schedule card or path information, and the path information indicates a path to obtain the schedule to be shared.

In a specific implementation, the determining unit 601 is specifically configured to determine the schedule to be shared in response to a selection operation by the first user on a schedule page. Here, the schedule page comprises the schedule to be shared.

The sharing unit 602 is specifically configured to, in response to a share operation by the first user on the schedule to be shared, add path information corresponding to the schedule to be shared to the target object.

In a specific implementation, the sharing unit 602 is specifically configured to, in response to a trigger operation by the first user on a sharing component in the schedule page, display a page comprising the target object; and in response to a selected operation by the first user on the page with respect to the target object, add the path information corresponding to the schedule to be shared to the target object.

In a specific implementation, the sharing unit 602 is specifically configured to, in response to a trigger operation by the first user on a path information copy component in the schedule page, obtain the path information corresponding to the schedule to be shared; and in response to a selected operation by the first user on the target object, add the path information corresponding to the schedule to be shared to the target object.

In a specific implementation, the path information is a link corresponding to the schedule to be shared.

In a specific implementation, the apparatus further comprises an acquisition unit and a rendering unit.

The acquisition unit is configured to, in response to a trigger operation by the second user on the path information corresponding to the schedule to be shared, acquire an identifier corresponding to the schedule to be shared and authority information of the second user for the schedule to be shared from the path information corresponding to the schedule to be shared.

The acquisition unit is further configured to acquire schedule information and interactive information corresponding to the schedule to be shared from a calendar server according to the identifier and the authority information of the second user for the schedule to be shared. The calendar server stores the schedule information corresponding to the schedule to be shared, and the interactive information indicates a content that the second user is capable of interacting with the schedule to be shared.

The rendering unit is configured to, using the schedule information and the interactive information, render the path information corresponding to the schedule to be shared into a schedule card, and display the schedule information and the interactive information in the schedule card.

In a specific implementation, the target object is a shared document.

In a specific implementation, the apparatus further comprises an acquisition unit. The schedule to be shared presented in the target object is generated in the following ways.

The acquisition unit is configured to, in response to the trigger operation of the first user, acquire a schedule block of the schedule to be shared through a sharing platform, and the schedule block is generated by a schedule server based on a data standard of the sharing platform, and the data standard is used to indicate a field that needs to be displayed in the schedule block.

The display unit 603 is further configured to display the schedule block of the schedule to be shared.

In a specific implementation, the acquisition unit is specifically configured to send a schedule insertion request to the sharing platform, the schedule insertion request comprising an identifier of the schedule to be shared, so as to enable the sharing platform to search for the schedule block locally according to the identifier of the schedule to be shared, or request the schedule block from the schedule server; and receive the schedule block sent by the sharing platform.

In a specific implementation, the apparatus further comprises a receiving unit and a transmitting unit.

The receiving unit is configured to receive an update message sent by the sharing platform, and the update message comprises an identifier of the schedule block and the update message is sent by the schedule server to the sharing platform.

The determining unit 601 is specifically configured to determine authority information of the second user for the schedule block according to the identifier of the schedule block.

The transmitting unit is configured to send an update request to the sharing platform according to the authority information of the second user for the schedule block. The update request is used for requesting updated schedule information conforming to the authority information of the second user for the schedule block.

The receiving unit is further configured to receive the updated schedule information conforming to the authority information of the second user for the schedule block sent by the sharing platform and display the updated schedule information.

It should be noted that the implementation of each unit in this embodiment can be found in the descriptions of the aforementioned method embodiment, and will not be repeated here.

FIG. 7 is a structural schematic diagram of an electronic device 700 suitable for implementing the embodiments of the present disclosure. A terminal device in the embodiments of the present disclosure may include, but is not limited to, mobile terminals such as a mobile phone, a notebook computer, a digital broadcasting receiver, a personal digital assistant (PDA), a tablet computer (PAD), a portable multimedia player (PMP), a vehicle-mounted terminal (such as a vehicle-mounted navigation terminal), or the like, and fixed terminals such as a digital TV, a desktop computer, or the like. The electronic device shown in FIG. 7 is only an example, and should not impose any limitations on the functionality and scope of use of the embodiments of the present disclosure.

As shown in FIG. 7, the electronic device 700 may comprises a processing apparatus 701 (e.g., a central processing unit, a graphics processing unit, etc.), which can perform various suitable actions and processing according to a program stored in a read-only memory (ROM) 702 or a program loaded from a storage apparatus 708 into a random-access memory (RAM) 703. The RAM 703 further stores various programs and data required for operations of the electronic device 700. The processing apparatus 701, the ROM 702, and the RAM 703 are interconnected by means of a bus 704. An input/output (I/O) interface 705 is also connected to the bus 704.

Usually, the following apparatus may be connected to the I/O interface 705: an input apparatus 706 including, for example, a touch screen, a touch pad, a keyboard, a mouse, a camera, a microphone, an accelerometer, a gyroscope, or the like; an output apparatus 707 including, for example, a liquid crystal display (LCD), a loudspeaker, a vibrator, or the like; a storage apparatus 708 including, for example, a magnetic tape, a hard disk, or the like; and a communication apparatus 709. The communication apparatus 709 may allow the electronic device 700 to be in wireless or wired communication with other devices to exchange data. While FIG. 7 illustrates the electronic device 700 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried on a non-transitory computer-readable medium. The computer program includes program codes for performing the methods shown in the flowcharts. In such embodiments, the computer program may be downloaded online through the communication apparatus 709 and installed, or may be installed from the storage apparatus 708, or may be installed from the ROM 702. When the computer program is executed by the processing apparatus 701, the above-mentioned functions defined in the method of the embodiments of the present disclosure are performed.

The electronic device provided in the embodiment of the present disclosure and the schedule sharing method provided in the above embodiment belong to the same inventive concept. Technical details not fully described in this embodiment can be found in the above embodiment, and this embodiment has the same beneficial effects as the above embodiment.

An embodiment of the present disclosure provides a computer storage medium, on which a computer program is stored, which, when the program is executed by a processor, the schedule sharing method provided in the above embodiment is implemented.

It should be noted that the computer readable medium described above in the present disclosure may be a computer readable signal medium or a computer readable storage medium or any combination thereof. For example, the computer readable storage medium may be, but not limited to, an electric, magnetic, optical, electromagnetic, infrared, or semiconductor system, apparatus, or device, or any combination of them. More specific examples of the computer readable storage medium may include, but are not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination of them. In the present disclosure, the computer readable storage medium may be any tangible medium containing or storing a program that can be used by or in combination with an instruction execution system, apparatus, or device. In the present disclosure, the computer readable signal medium may include a data signal that propagates in a baseband or as a part of a carrier and carries computer readable program codes. The data signal propagating in such a manner may take a variety of forms, including but not limited to an electromagnetic signal, an optical signal, or any appropriate combination thereof. The computer readable signal medium may also be any computer readable medium other than the computer readable storage medium. The computer readable signal medium may send, propagate, or transmit a program used by or in combination with an instruction execution system, apparatus, or device. The program code contained on the computer readable medium may be transmitted by using any suitable medium, including but not limited to an electric wire, an optical cable, radio frequency (RF), and the like, or any appropriate combination of them.

In some implementations, a client and a server may communicate by using any currently known or future developed network protocol, such as HTTP (HyperText Transfer Protocol), and may be interconnected with digital data communication (for example, the communications network) in any form or medium. Examples of the communication network include a local area network (“LAN”), a wide area network (“WAN”), the Internet (for example, the Internet), and an end-to-end network (for example, an ad hoc end-to-end network), as well as any currently known or future developed network.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform: in response to a trigger operation of a first user, determine a schedule to be shared; in response to a share operation of the first user, share the schedule to be shared to a target object, the target object being a page or webpage accessed by a user having an access authority; and in response to a second user accessing the target object, display an operation control matching authority information of the second user on a page corresponding to the schedule to be shared, thus allowing the second user to achieve to interact with the schedule to be shared through the operation control, the authority information of the second user being used to indicate whether the second user has an access authority to the schedule to be shared.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or may be connected to an external computer (e.g., connected through the Internet from an Internet Service Provider).

The flowcharts and block diagrams in the accompanying drawings illustrate system architectures, functions, and operations that may be implemented according to the system, method, and computer program products provided by the various embodiments of the present disclosure. In this regard, each block in the flowcharts or block diagrams may represent a module, a program segment, or a part of code, and the module, the program segment, or the part of code includes one or more executable instructions for implementing specified logic functions. It should also be noted that, in some alternative implementations, functions marked in the blocks may also occur in an order different from the order designated in the accompanying drawings. For example, two consecutive blocks can actually be executed substantially in parallel, and they may sometimes be executed in a reverse order, which depends on involved functions. It should also be noted that each block in the flowcharts and/or block diagrams and combinations of the blocks in the flowcharts and/or block diagrams may be implemented by a dedicated hardware-based system for executing specified functions or operations, or may be implemented by a combination of a dedicated hardware and computer instructions.

The units described in the embodiments of the present disclosure may be implemented by software, or may be implemented by hardware. The name of the unit/module does not constitute a limitation on the unit itself in certain circumstances.

The functions described above in the present disclosure may be executed at least in part by one or more hardware logic components. For example, without limitations, exemplary types of the hardware logic components that can be used include: a field programmable gate array (FPGA), an application specific integrated circuit (ASIC), an application specific standard product (ASSP), a system on chip (SOC), a complex programmable logic device (CPLD), and the like.

In the context of the present disclosure, a machine readable medium may be a tangible medium that may contain or store a program for use by or in combination with an instruction execution system, apparatus, or device. The machine readable medium may be a machine readable signal medium or a machine readable storage medium. The machine readable medium may include but not be limited to an electronic, magnetic, optical, electromagnetic, infrared, or semiconductor system, apparatus, or device, or any appropriate combination of them. More specific examples of the machine readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination of them.

It should be noted that various embodiments in the specification are described in a progressive manner, and each embodiment focuses on the differences with other embodiments, and the same and similar parts between various embodiments can be referred with each other. As for the system or device disclosed in the embodiment, because it corresponds to the method disclosed in the embodiment, the description is relatively simple, and it is sufficient to refer to the description in the method part. Furthermore, it will be appreciated that the various embodiments may be combined with each other without contradiction, for example, by applying steps or features from one embodiment to other embodiments.

It should be understood that in the present disclosure, “at least one” means one or more, “a plurality of” means two or more. “and/or”, which is used to describe the association relationship of associated objects, indicates the existence of three possible relationships. For example, “A and/or B” can mean only A, only B, or the simultaneous presence of both A and B, where A and B can be singular or plural. The character “/” generally denotes an “or” relationship between the preceding and subsequent associated objects. The term “at least one of the following items” or similar expressions refer to any combination of these items, including a single item or a combination of plural items. For example, “at least one of a, b, or c” can represent: a, b, c, “a and b”, “a and c”, “b and c”, or “a, b, and c”, where a, b, and c can be singular or plural.

It should also be noted that, in the specification, relational terms such as first and second are only used to distinguish one entity or operation from another entity or operation, and do not necessarily require or imply any such actual relationship or order between these entities or operations. Moreover, the term “comprise”, “include”, or any other variations thereof are intended to cover non-exclusive inclusions, such that a process, method, article, or apparatus that comprises a series of elements not only comprises those elements but may also comprise other elements not explicitly listed or elements that are inherent to such process, method, article, or apparatus. In the absence of further limitations, the fact that an element is limited by the phrase “comprising a . . . ” does not exclude the existence of additional identical elements in the process, method, article, or apparatus that comprises the described element.

The steps of the methods or algorithms described in conjunction with the embodiments disclosed herein may be implemented directly in hardware, a software module executed by a processor, or a combination of both. The software module may be set in a random access memory (RAM), a memory, a read-only memory (ROM), an electrically programmable ROM, an electrically erasable programmable ROM, a register, a hard disk, a removable disk, a CD-ROM, or any other form of storage medium known in the technical field.

The above description of the disclosed embodiments enables those skilled in the art to implement or use the present disclosure. Various modifications to these embodiments will be apparent to those skilled in the art, and the general principles defined herein may be implemented in other embodiments without departing from the spirit or scope of the present disclosure. Therefore, the present disclosure should not be limited to the embodiments shown herein, but is intended to conform the broadest scope consistent with the principles and novel features disclosed herein.

1. A schedule sharing method, comprising:
in response to a trigger operation of a first user, determining a schedule to be shared;
in response to a share operation of the first user, sharing the schedule to be shared to a target object, the target object being a page or webpage accessed by a user having an access authority; and
in response to a second user accessing the target object, displaying an operation control matching authority information of the second user on a page corresponding to the schedule to be shared, allowing the second user to achieve to interact with the schedule to be shared through the operation control, the authority information of the second user being used to indicate whether the second user has an access authority to the schedule to be shared.

2. The method according to claim 1, wherein the in response to a second user accessing the target object, displaying an operation control matching authority information of the second user on a page corresponding to the schedule to be shared comprises:
in response to the second user accessing the target object and the authority information of the second user indicating that the second user is not a participant of the schedule to be shared, displaying a first operation control on the page corresponding to the schedule to be shared, allowing the second user to apply to join the schedule to be shared by triggering the first operation control.

3. The method according to claim 1, wherein the in response to a second user accessing the target object, displaying an operation control matching authority information of the second user on a page corresponding to the schedule to be shared comprises:
in response to the second user accessing the target object and the authority information of the second user indicating that the second user is a participant of the schedule to be shared, displaying a second operation control in the page corresponding to the schedule to be shared, allowing the second user to reply to the schedule to be shared through the second operation control;
wherein the second operation control comprises at least one of following: a first control for accepting the schedule to be shared, a second control for rejecting the schedule to be shared, and a pending control.

4. The method according to claim 3, further comprising:
in response to a trigger operation of the second user on a target control, updating a content corresponding to the target control on the page corresponding to the schedule to be shared, wherein the target control is any one of second operation controls.

5. The method according to claim 1, further comprising:
in response to the second user accessing the target object, displaying schedule information matching the authority information of the second user in the page corresponding to the schedule to be shared according to the authority information of the second user.

6. The method according to claim 5, wherein the in response to the second user accessing the target object, displaying schedule information matching the authority information of the second user in the page corresponding to the schedule to be shared according to the authority information of the second user comprises:
in response to the second user accessing the target object and the second user having the access authority to the schedule to be shared, displaying first schedule information in the page corresponding to the schedule to be shared, the first schedule information comprising detailed information related to the schedule to be shared.

7. The method according to claim 5, wherein the in response to the second user accessing the target object, displaying schedule information matching the authority information of the second user in the page corresponding to the schedule to be shared according to the authority information of the second user comprises:
in response to the second user accessing the target object and the second user not having the access authority to the schedule to be shared, displaying second schedule information in the page corresponding to the schedule to be shared, the second schedule information comprising summary information related to the schedule to be shared.

8. The method according to claim 1, wherein the in response to a trigger operation of a first user, determining a schedule to be shared, comprises:
in response to an insert operation triggered by the first user in the target object, receiving a schedule identifier input by the first user, and displaying one or more schedules comprising the schedule identifier; and
in response to a selection operation by the first user on the one or more schedules, determining a selected schedule as the schedule to be shared.

9. The method according to claim 8, wherein the in response to a share operation of the first user, sharing the schedule to be shared to a target object comprises:
in response to a confirmation operation by the first user on the schedule to be shared, inserting the schedule to be shared into the target object in a form of a schedule card.

10. The method according to claim 1, further comprising:
in response to a trigger operation by the second user on the schedule to be shared, switching a display mode of the schedule to be shared, wherein the display mode comprises a schedule card or path information, and the path information indicates a path to obtain the schedule to be shared.

11. The method according to claim 1, wherein the in response to a trigger operation of a first user, determining a schedule to be shared comprises:
in response to a selection operation by the first user on a schedule page, determining the schedule to be shared, wherein the schedule page comprises the schedule to be shared; and
the in response to a share operation of the first user, sharing the schedule to be shared to a target object comprises:
in response to a share operation by the first user on the schedule to be shared, adding path information corresponding to the schedule to be shared to the target object;
wherein the path information comprises a link corresponding to the schedule to be shared.

12. The method according to claim 11, wherein the in response to a share operation by the first user on the schedule to be shared, adding path information corresponding to the schedule to be shared to the target object comprises:
in response to a trigger operation by the first user on a sharing component in the schedule page, displaying a page comprising the target object; and
in response to a selected operation by the first user on the page with respect to the target object, adding the path information corresponding to the schedule to be shared to the target object.

13. The method according to claim 11, wherein the in response to a share operation by the first user on the schedule to be shared, adding path information corresponding to the schedule to be shared to the target object comprises:
in response to a trigger operation by the first user on a path information copy component in the schedule page, obtaining the path information corresponding to the schedule to be shared; and
in response to a selected operation by the first user on the target object, adding the path information corresponding to the schedule to be shared to the target object.

14. The method according to claim 11, further comprising:
in response to a trigger operation by the second user on the path information corresponding to the schedule to be shared, acquiring an identifier corresponding to the schedule to be shared and authority information of the second user for the schedule to be shared from the path information corresponding to the schedule to be shared;
acquiring schedule information and interactive information corresponding to the schedule to be shared from a calendar server according to the identifier and the authority information of the second user for the schedule to be shared, wherein the calendar server stores the schedule information corresponding to the schedule to be shared, and the interactive information indicates a content that the second user is capable of interacting with the schedule to be shared; and
by means of the schedule information and the interactive information, rendering the path information corresponding to the schedule to be shared into a schedule card, and displaying the schedule information and the interactive information in the schedule card.

15. The method according to claim 1, wherein the target object comprises a shared document.

16. The method according to claim 1, wherein the schedule to be shared presented in the target object is generated by:
in response to the trigger operation of the first user, acquiring a schedule block of the schedule to be shared through a sharing platform, wherein the schedule block is generated by a schedule server based on a data standard of the sharing platform, and the data standard is used to indicate a field to be displayed in the schedule block; and
displaying the schedule block of the schedule to be shared.

17. The method according to claim 16, wherein the acquiring a schedule block of the schedule to be shared through a sharing platform comprises:
sending a schedule insertion request to the sharing platform, wherein the schedule insertion request comprises an identifier of the schedule to be shared to enable the sharing platform to search for the schedule block locally according to the identifier of the schedule to be shared, or request the schedule block from the schedule server; and
receiving the schedule block sent by the sharing platform.

18. The method according to claim 16, further comprising:
receiving an update message sent by the sharing platform, wherein the update message comprises an identifier of the schedule block and the update message is sent by the schedule server to the sharing platform;
determining authority information of the second user for the schedule block according to the identifier of the schedule block;
sending an update request to the sharing platform according to the authority information of the second user for the schedule block, wherein the update request is used for requesting updated schedule information conforming to the authority information of the second user for the schedule block; and
receiving the updated schedule information conforming to the authority information of the second user for the schedule block sent by the sharing platform and displaying the updated schedule information.

19. An electronic device, comprising a processor and a memory, wherein
the memory is configured to store instructions or computer programs; and
the processor is configured to execute the instructions or the computer programs in the memory to enable the electronic device to perform a schedule sharing method,
wherein the schedule sharing method comprises:
in response to a trigger operation of a first user, determining a schedule to be shared;
in response to a share operation of the first user, sharing the schedule to be shared to a target object, the target object being a page or webpage accessed by a user having an access authority; and
in response to a second user accessing the target object, displaying an operation control matching authority information of the second user on a page corresponding to the schedule to be shared, allowing the second user to achieve to interact with the schedule to be shared through the operation control, the authority information of the second user being used to indicate whether the second user has an access authority to the schedule to be shared.

20. A non-transitory computer-readable storage medium, comprising instructions which, when run on a computer, cause the computer to perform the method according to claim 1.
